(19) United States
(12) Patent Application Publication
(10) Pub. No.: US 2024/0255190 A1
(43) Pub. Date: Aug. 1, 2024

(54) SYSTEMS AND METHODS FOR UTILIZING GEOTHERMAL COOLING TO COOL OPEN AIR STRUCTURES

(71) Applicant: Visionergy, LLC, Upper Marlboro, MD (US)

(72) Inventor: Terry Pisano Goolsby, Upper Marlboro, MD (US)

(73) Assignee: Visionergy, LLC, Upper Marlboro, MD (US)

(21) Appl. No.: 18/424,157

(22) Filed: Jan. 26, 2024

Related U.S. Application Data
(60) Provisional application No. 63/441,777, filed on Jan. 28, 2023.
(60) Provisional application No. 63/448,394, filed on Feb. 27, 2023.

(51) Int. Cl. F24T 50/00; A01K 1/00; F24F 5/00

(52) U.S. Cl. CPC F24T 50/00; A01K 1/0082; F24F 5/0046; F24F 2005/0057

(57) ABSTRACT

A geothermal cooling system comprises an open-air structure and a closed, geothermal loop configured to cool an environment in which the open-air structure is located. The loop comprises a below-ground tubing field comprising one or more tubing loops, at least one above-ground bank of tubing coupled to the open-air structure, at least one fluid supply line fluidically coupling the below-ground tubing field and the above-ground bank of tubing, and at least one fluid return line fluidically coupling the below-ground tubing field and the above-ground bank of tubing. The loop comprises at least one pump operably coupled to the supply line and configured to apply a pressure differential sufficient to draw fluid from the below-ground tubing field through the supply line and into the above-ground bank of tubing arranged to circulate the fluid via gravity through the above-ground bank of tubing and return the fluid to the below-ground tubing field.

### CROSS-REFERENCE TO RELATED APPLICATIONS

This application claims priority to U.S. Provisional Patent Application No. 63/441,777, filed Jan. 28, 2023, and entitled “Cow Cooling Assembly,” and U.S. Provisional Patent Application No. 63/448,394, filed Feb. 27, 2023, and entitled “Cow Cooling Bed Assembly,” the entire content each of which is incorporated by reference herein.

### TECHNICAL FIELD

The present disclosure relates generally to geothermal cooling and, more particularly, to systems and methods for utilizing geothermal cooling for cooling open-air structures, including, for example, barns and other buildings used to house livestock.

### INTRODUCTION

The section headings used herein are for organizational purposes only and are not to be construed as limiting the subject matter described in any way.

An improvement in the worldwide standard of living is expected to drive an increase in the global demand for livestock products in the coming years. Meanwhile, climate change, and specifically global warming, threatens livestock production due, for example, to its impact on the quality of feed crops and forage, water availability, animal and milk production, livestock diseases, animal reproduction, and biodiversity. Extreme heat events throughout various parts of the world in recent years have, for example, resulted in mass livestock casualties, which will continue with the rise in average global temperatures.

Dairy cows, for example, are particularly susceptible to increasing temperatures associated with global warming. Heat stress in cows begins to occur when the ambient temperature and humidity go above animal specific thresholds. These thresholds are estimated by the temperature humidity index (THI), and although they generally depend on the animals themselves, a THI of more than 70 is generally regarded to be the point when heat stress becomes a problem, and less milk is produced, where THI+=0.4 (T+T_{w})+15, where T is the air temperature measured in the shade and T_{w} is the wet-bulb temperature, all expressed in degrees Fahrenheit (° F.).

With global temperatures projected to increase further, the THIs in many parts of the world will lead to significant heat stress for cows, as well as other livestock, if nothing is done to alleviate the hot weather's effects on the animals. A variety of livestock cooling technologies and methods have therefore been developed in an effort to alleviate heat stress. Existing cooling technologies, however, are generally not considered to be environmentally friendly, sustainable solutions, and instead may contribute to the problems associated with global warming by further draining depleted water supplies and stressing electrical grids, utilizing non-renewable energy sources (e.g., such as fossil fuels), and generating carbon dioxide (CO₂) emissions. Such cooling technologies and methods can also be inefficient and wasteful, such as, for example, the use of large amounts of water sprayed for evaporative cooling technologies and techniques that rely on cooled air provided by fossil fuel fed air conditioning (AC) which can easily escape from open-air structures housing the animals. Furthermore, such cooling technologies may not be feasible in some parts of the world, for example, areas with very limited water supplies that do not have access to the quantities of water that would be required to prevent heat stress (i.e., areas in severe drought conditions), and/or areas where the humidity prevents water spray from evaporating.

There is consequently a need for environmentally sustainable systems and methods for cooling livestock, including, for example, dairy cows, which can help prevent heat stress in livestock associated with rising global temperatures, without contributing to the environmental stresses stemming from climate change. Thus, it is desirable to provide systems and methods that can efficiently and cost-effectively cool open-air structures, such as barns used to house livestock, utilizing a renewable resource. It is also desirable to provide systems and methods that can cool open-air structures in various types of environments, including both drought-stricken and high humidity environments. It is further desirable to provide systems and methods that utilize a simplistic design for cooling open-air structures, such as barns, without requiring the heat pumps/heat exchangers that are often associated with housing structures having a building envelope and other closed-off, insulated living spaces generally used by the human population.

### SUMMARY

Exemplary embodiments of the present disclosure may demonstrate one or more of the above-mentioned desirable features. Other features and/or advantages may become apparent from the description that follows.

Additional objects and advantages will be set forth in part in the description which follows, and in part will be obvious from the description, or may be learned by practice of the present teachings. At least some of the objects and advantages of the present disclosure may be realized and attained by means of the elements and combinations particularly pointed out in the appended claims.

In accordance with one embodiment of the present disclosure, a geothermal cooling system for an open-air structure comprises an open-air structure and a closed, geothermal loop configured to cool an environment in which the open-air structure is located. The geothermal loop comprises a below-ground tubing field comprising one or more tubing loops and at least one above-ground bank of tubing coupled to a portion of the open-air structure. The geothermal loop also comprises at least one fluid supply line fluidically coupling the below-ground tubing field and the at least one above-ground bank of tubing and at least one fluid return line fluidically coupling the below-ground tubing field and the at least one above-ground bank of tubing. The geothermal loop further comprises at least one pump operably coupled to the fluid supply line and configured to apply a pressure differential sufficient to draw fluid from the below-ground tubing field through the fluid supply line and into the at least one above-ground bank of tubing. The at least one above-ground bank of tubing is arranged to circulate the fluid via gravity through the at least one above-ground bank of tubing and return the fluid to the below-ground tubing field through the at least one fluid return line.

In accordance with another embodiment of the present disclosure, a method for cooling an open-air structure comprises pumping fluid from a below-ground tubing field into at least one above-ground bank of tubing. The at least one above-ground bank of tubing is coupled to a portion of an open-air structure. The method also comprises circulating the fluid through the at least one above-ground bank of tubing and returning the fluid from the at least one above-ground bank of tubing to the below-ground tubing field via gravitational flow. The method also comprises cooling an environment in which the open-air structure is located via the circulation of the fluid through the at least one above-ground bank of tubing.

It is to be understood that both the foregoing general description and the following detailed description are exemplary and explanatory only and are not restrictive of the present disclosure and claims, including equivalents. It should be understood the present disclosure and claims, in their broadest sense, could be practiced without having one or more features of these exemplary aspects and embodiments.

### BRIEF DESCRIPTION OF THE DRAWINGS

The accompanying drawings, which are incorporated in and constitute a part of this specification, illustrate various non-limiting embodiments of the present disclosure and together with the description, serve to explain certain principles. In the drawings:

FIG. 1 is a sectional view of a geothermal cooling system implemented within an open-air structure in accordance with one embodiment;

FIG. 2 is a schematic view of a below-ground tubing field of the geothermal system of FIG. 1;

FIG. 3 is an isolated, perspective view of an above-ground bank of continuous tubing of the geothermal system of FIG. 1;

FIG. 4 is an isolated, side view of an in-line circulatory pump of the geothermal system of FIG. 1;

FIG. 5 is an enlarged, partial view of the geothermal system of FIG. 1, illustrating an exemplary implementation of the above-ground bank of continuous tubing and the in-line circulatory pump of FIGS. 3 and 4;

FIG. 6 is a sectional view of a geothermal cooling system implemented within an open-air structure in accordance with another embodiment;

FIG. 7 is an isolated partial, perspective view of an above-ground bank of tubing of the geothermal system of FIG. 6;

FIG. 8 is a schematic, cross-sectional view of the above-ground bank of tubing of FIG. 7;

FIG. 9 is an isolated, side view of an in-line circulatory pump of the geothermal system of FIG. 6; and

FIG. 10 is a flowchart illustrating exemplary parts of a workflow in accordance with one or more embodiments of the present disclosure.

### DETAILED DESCRIPTION

The present disclosure solves one or more of the above-mentioned problems and/or achieves one or more of the above-mentioned desirable features. Other features and/or advantages may become apparent from the description which follows.

As the world faces the consequences of global warming and the depletion of non-renewable resources, sustainable energy has become a crucial component in the shift towards a more sustainable future. This issue is particularly prevalent when considering livestock production and the effects of global warming on dairy production. There is a continued need for environmentally sustainable systems and methods for cooling livestock, including, for example, dairy cows, which can help prevent heat stress in livestock associated with rising global temperatures, without contributing to the environmental stresses stemming from climate change, for example, by further depleting water supplies, stressing electric grids, and/or emitting CO₂ into the environment. The present disclosure contemplates, for example, exploiting the natural cooling abundance of the earth's underground temperatures to cool spaces housing livestock, such as, for example, cows. The present disclosure, therefore, contemplates systems and methods that can efficiently and cost-effectively cool open-air structures, such as barns used to house livestock, utilizing the renewable resource of geothermal cooling to harness the constant temperature of the shallow earth.

In this manner, the systems and methods of the present disclosure contemplate utilizing a closed, geothermal loop to use the stable temperatures below ground to shed excess heat from open-air structures such as barns and other shelters, and the animals housed within and/or protected by such structures. More specifically such closed, geothermal loop systems can provide cooling by pumping fluid, such as water, from a below-ground tubing field to an above-ground bank of tubing positioned at the open-air structure and circulating the warmed water back down into the below-ground tubing field. At basement or lower elevations, for example, the Earth's below-ground temperature generally stays at about 55 degrees Fahrenheit, no matter the Earth's surface temperature and environment, such as whether the environment is dry or humid. Thus, in various embodiments, the contemplated geothermal loops may be used to pump water, which has been cooled to about 55 degrees while being stored below the ground, up and into structures above the ground, where the cooled water is used in a convective cooling process. Furthermore, as the contemplated geothermal loop is a closed-loop cooling system, water is not allowed to enter or leave the system, thereby providing a sustainable system (i.e., which conserves water) even in drought-stricken environments. Such a closed-loop system also can avoid runoff that may cause deleterious environmental effects.

In some embodiments, for example, the contemplated geothermal cooling systems include an open-air structure configured to provide a degree of protection, such as shade if the structure comprises a roof or rafters structure and/or protection from the ground if the open-air structure comprises a floor structure, while allowing free movement of air between the open-air structure and an external environment in which the open-air structure is located. The geothermal cooling systems further comprise a closed, geothermal loop coupled to the open-air structure and configured to cool at least a portion of the interior of the open-air structure.

As used herein, the term “open-air structure” is intended to include various structures without a defined closed building envelope, such that the structure generally does not include a fully enclosed structure, but rather a structure, designed to protect people or assets (e.g., livestock) from the weather, such as providing shade or a barrier to portions of the exterior environment while allowing for the free movement of air and other elements, including, for example, water and/or smoke from regions protected by the structure to the environment in which the structure is located. Open-air structures can include barns that are used to house livestock, or simpler roof/trough type structures, pavilions, and the like used for protection of livestock while out in the field feeding, etc. While such livestock open-air structures are described herein, those of ordinary skill in the art would understand that open-air structures can be used for various purposes, including various agricultural purposes, as well as various non-agricultural purposes, including, for example, for entertainment, performances, sports, or shopping.

As open-air structures do not have a traditional building envelope and are exposed to the elements, such structures do not lend themselves to traditional refrigerant-based cooling methods, such as, for example, air conditioning (or HVAC) systems that include heat pumps and/other refrigerant based heat exchangers and components, such as compressors. Indeed, the openness of such structures leads to inefficiencies (e.g., due to the cooled A/C air escaping and humid air freely flowing in). The coolant used with such refrigerant-based systems and the CO₂ emissions associated with such systems also have negative environmental impacts. Furthermore, the use of coolant, heat exchangers, and/or heat pumps may increase the complexity of such systems, thereby also increasing the cost of such systems. Consequently, in some embodiments, the contemplated geothermal cooling systems and methods utilize a closed, geothermal loop that is configured to use a simple convection cooling process based on fluid, such as water, that does not require compression to be in its liquid state, to cool at least a portion of an interior of an open-air structure.

In some embodiments, for example, the geothermal loop includes a below-ground tubing field comprising one or more tubing loops, at least one fluid supply line and at least one fluid return line. In one embodiment, the below-ground tubing field can comprise a continuous coil forming multiple overlapping loops of flexible tubing, such as, for example, in a coiled configuration. For example, the tubing may comprise high-density polyethylene (HDPE) tubing, for example, commercially available as HDPE tubing coils.

Ground (i.e., the earth) where the open-air structure is located can be excavated to bury the below-ground tubing field at an appropriate depth below a ground surface for a particular cooling application. In various applications, as will be described further below, it may be desirable to bury the below-ground tubing field at a depth of about 8 to 10 feet below the ground surface.

The geothermal loop also includes at least one above-ground bank of tubing fluidically coupled with the below-ground tubing field via the at least one fluid supply line and the at least one fluid return line. As will be described in more detail below, the at least one above-ground bank of tubing can be coupled with a portion of the open-air structure, such as, for example, with rafters of the structure, a roof structure, and/or a floor structure of the open-air structure. In this manner, when used in agricultural applications, such as, for example, in open-air structures used to house livestock, such as, for example, cows (e.g., dairy cows) or cattle, the at least one above-ground bank of tubing is configured to be positioned above and/or below at least one animal (e.g. cow) protected by the open-air structure to provide cooling to the animal. For example, the above-ground bank of tubing can be located above a stall that is used to house the animal (e.g., cow) and/or within a bed (floor structure) of the stall.

The geothermal loop further includes at least one pumping mechanism, such as a circulatory pump or circulator pump, configured to draw a fluid, such as, for example, water out from the fluid supply line of the below-ground tubing field and into the at least one above-ground bank of tubing. Those having ordinary skill in the art will understand that various types and configurations of pumping mechanisms can be used to circulate fluid throughout the contemplated geothermal loops, and that the illustrated geothermal loops are not limited to the exemplary pumps shown. In various embodiments, for example, the at least one above-ground bank of tubing is configured to allow circulation of the fluid through the at least one above-ground bank of tubing and into the at least one fluid return line of the below-ground tubing field. For example, the at least one above-ground bank of tubing can include a continuous length of tubing that may be arranged in a variety of overlapping patterns, such as, but not limited to, a snake pattern (shown in the figures), a snail pattern, or a meandering pattern, as those having ordinary skill in the art are familiar with. Various other overlapping patterns that allow for a relatively long length of tubing to be used but in a footprint that is relatively smaller in dimension than the overall length of the tubing can be used and are contemplated as within the scope of the present disclosure.

In an embodiment, the tubing of the above-ground bank can be made of copper, or other materials commonly used to provide good thermal conductivity.

The above-ground bank of tubing may be arranged at a downward slope such that an elevation of a first end of the continuous length of tubing which is coupled to the fluid supply line is at an elevation higher than a second end of the continuous length of tubing which is coupled to the fluid return line. Such an arrangement can allow for a gravitational flow of fluid from the above-ground bank of tubing to the below-ground tubing field.

In some embodiments, to further increase the pressure and assist with the flow of the fluid through the above-ground bank of tubing to the below-ground tubing field, the diameter of the tubing of the above-ground bank can be smaller than a diameter of the fluid supply line. In this manner, a closed-geothermal loop is created that circulates the cooling fluid (e.g., water) in a constant loop, by drawing cooled fluid from the tubing within the ground up into the tubing in the open-air structure, where it is situated at the open-air structure and used to cool an environment in which the open-air structure is located, including, e.g., cooling animals using the protection of the open-air structure. The closed, geothermal loop can then return the cooling fluid to the below-ground tubing field, via gravity, where it is cooled again (prior to once again being drawn up into the above-ground bank of tubing.

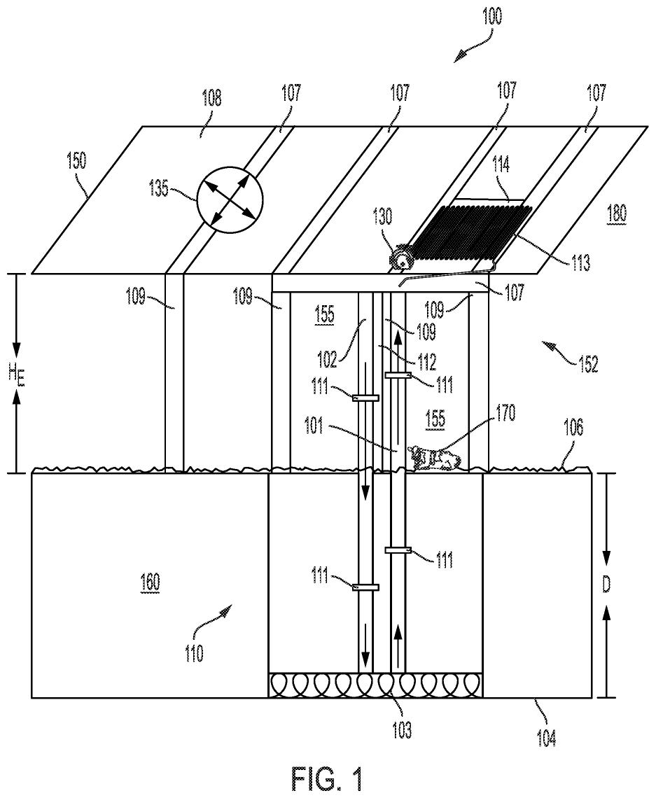

With reference now to FIGS. 1-5, one embodiment of a geothermal cooling system 100 for an open-air structure in accordance with the present disclosure is illustrated. The geothermal cooling system 100 includes an open-structure 150, configured, for example, to protect livestock, including, but not limited to, at least one cow 170. In FIG. 1, the geothermal cooling system 100 is depicted in a sectional view and comprises a closed loop extending from an excavated region 104, for example, about 10 feet below a ground surface 106, to above the ground surface 106 to an elevated height H_{E}. In some embodiments, for example, the elevated height H_{E} may correspond with a rafter height (i.e., the height of rafters 107 supporting a roof 108 of the open-air structure 150), which in some embodiments is about 10 feet above the ground surface 106. As discussed above, the open-air structure 150 is configured to provide shade via the roof 108 to a region 152 beneath the roof 108, while allowing free movement of air between the region 152 and an external environment 180 in which the open-air structure is located. In an embodiment, the open-air structure 150 may be a barn and the region 152 may be the interior of the barn, but other structures such as pavilions and the like are also contemplated as discussed above.

The geothermal cooling system 100 also includes a geothermal loop 110 that is configured to cool at least a portion of the region 152, and in particular a portion in which livestock, such as the cow 170, is situated for protection by the open-air structure 150. The geothermal loop 110, for example, includes a below-ground tubing field 103, at least one above-ground bank of tubing 113 fluidically coupled with the below-ground tubing field 103, and at least one pumping device 130 (e.g., a circulatory pump).

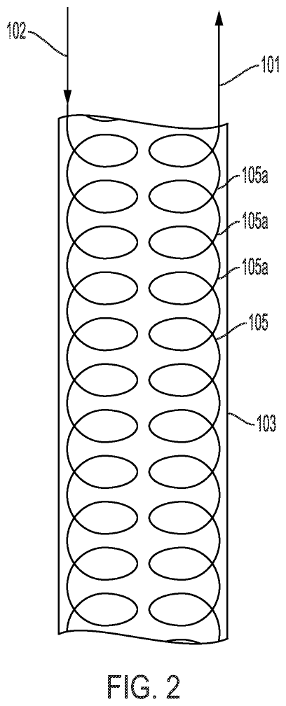

As best illustrated perhaps in the isolated, arial view of FIG. 2, the below-ground tubing field 103 includes one or more tubing loops 105a. In one embodiment, the below-ground tubing field 103 can comprise multiple overlapping loops 105a of flexible tubing 105, such as, for example, multiple loops 105a of high-density polyethylene (HDPE) tubing 105. In an embodiment, the multiple overlapping loops 105a can be in the form of a coil, and be, for example, commercially available as HDPE slinky tubing coils. As illustrated in FIG. 1, in some embodiments, ground 160 (i.e., earth) by the open-air structure 150 can be excavated to bury the below-ground tubing field 103 at an appropriate depth D below the ground surface 106.

In one exemplary embodiment, the below-ground tubing field 103 can be buried at a depth D of about 8 to 10 feet below the ground surface 106 (i.e., such that the excavated surface 104 is about 8 to 10 feet below the ground surface 106). In such embodiments, the below-ground tubing field 103 can comprise about a 500-foot length of the coiled tubing 105 formed into overlapping loops 105a.

Those of ordinary skill in the art will understand that the below-ground tubing field 103 illustrated in FIGS. 1 and 2 is exemplary only at that such fields 103 can have various types, configurations, and/or lengths of pipes 105 formed into various configurations of overlapping and non-overlapping loops 105a and buried at various depths D within the earth 160, without departing from the scope of the present disclosure and claims.

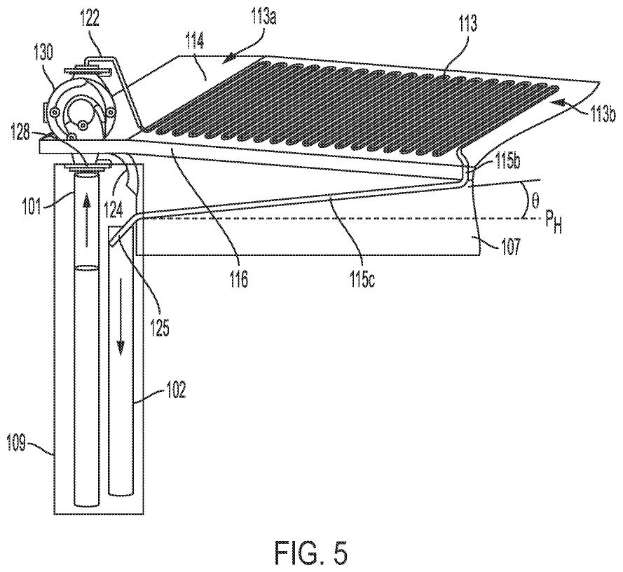

In contrast to the below-ground tubing field 103, as illustrated in FIGS. 1 and 5, the above-ground bank of tubing 113 is configured to be coupled at the open-air structure 150. In the embodiment of FIGS. 1-5, the open-air structure 150 comprises a roof structure 108 that is supported by a plurality of posts 109 (only three posts 109 being shown in the view of FIG. 1 for clarity purposes), such as, for example, a plurality of 4 by 4 posts, which are spaced apart throughout the region 152 of the open-air structure 150, and which are configured to provide support for the roof structure 108, rafters 107, and any rafter-high equipment that is situated within the open-air structure 150. In some embodiments, the posts 109 and rafters 107 are configured to support a rack (e.g., a wood rack) 114 and/or other structures (e.g., shelving) that are used to support the above-ground bank of tubing 113 and a pumping device 130 at an elevated height H_{E}. For example, as illustrated in the enlarged view of FIG. 5, in some embodiments, the rack 114 may have ledges 116 and supportive bracing 124, which are configured to secure the above-ground bank of tubing 113 and the pumping device 130 to the rack 114.

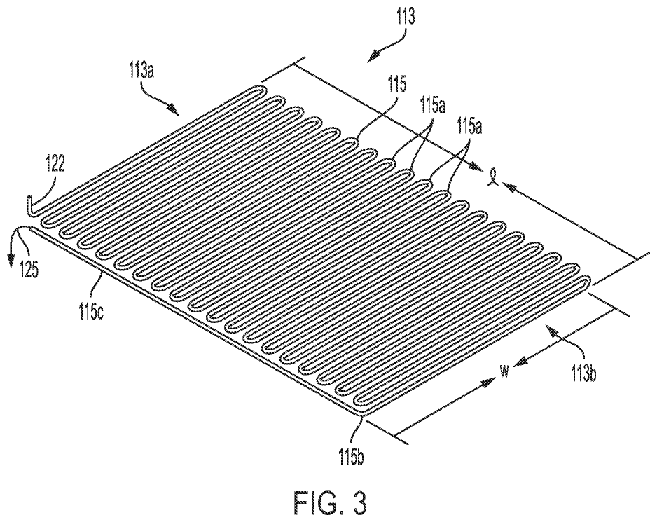

As best illustrated perhaps in the isolated and enlarged views of FIGS. 3 and 5, in some embodiments, the above-ground bank of tubing 113 includes a continuous length of tubing 115 in a series of overlapping loops 115a of tubing which can have various patterns as discussed above (a snake pattern being depicted here), and extending between an inlet curl 122 of the tubing 115 and an outlet curl 125 of the tubing 115. In various embodiments, for example, the tubing 115 can be copper having an outer diameter of about ⅜ inches and an inner diameter of about ¼ inches.

The geothermal cooling loop 110 also includes a fluid supply line and a fluid return line fluidically coupling the above-ground bank of tubing and the below-ground tubing field. For example, a fluid supply line 101, in the form of a straight (non-coiled or overlapping) length of tubing 101, coupled to the below-ground tubing field 103 and emerging from the below-ground region 104 and extending above the ground surface 106. A fluid return line 102, in the form of a second straight HDPE length 102 of about 20 feet, returning from above the ground surface 106 and heading back to the below-ground HDPE tubing field 103. In this manner, such embodiments can accommodate about 75 gallons of water in the geothermal loop 110.

More specifically, the inlet curl 122 connects to the pumping device 130, which is situated at a first end 113a of the tubing 113 and is connected to the fluid supply line 101 that is coupled to the below-ground tubing field 103 (i.e., such that the pumping device 130 can draw cooled water out from the fluid supply line 101). The outlet curl 125 is then positioned to deposit warmed water exiting the above-ground bank of tubing 113 back into the fluid return line 102 that is coupled to the below-ground tubing field 103 (i.e., to return the water to the below-ground tubing field 103 where it can be cooled again). In some embodiments, for example, a second end 113b of the tubing 113 includes a final curl 115b that is slanted downward (i.e., relative to a horizontal plane P_{H} that lies substantially parallel with the ground surface 106) and a straight length of the tubing 115c, which runs at a downward slope to the outlet curl 125 (see FIG. 5). In one embodiment for example, the straight length of tubing 115c runs at an angle θ₁ of about 4 degrees to about 6 degrees relative to the plane P_{H}.

In accordance with various embodiments, as discussed above, the above-ground bank of tubing 113 is supported by the rack 114 such that the bank of tubing 113 also runs at a downward slope (i.e., relative to the horizontal plane P_{H}) from the first end 113a of the bank of tubing 113 and to the second end 113b of the bank of tubing 113. In other words, an elevation of the first end 113a of the bank of tubing is higher than an elevation of the second end 113b of the bank of tubing 113. In one embodiment, for example, in accordance with the standard dimensions of a cow stall, both the above-ground bank of tubing 113 and the rack 114 supporting the tubing 113 have a width w of about 4 feet and a length l of about 6 feet (see FIG. 3), with the continuous tubing 115 forming overlapping lengths in a series of loops 115a that snake 180° back-and-forth in a 2-dimensional pattern each time the tube 115 reaches a side of the wood rack 114.

In this manner, a respective above-ground bank of tubing 113/rack 114 can be placed above each stall 155 (e.g., cow stall) in the barn 150, such that the above-ground bank of tubing 113 is positioned above an animal (e.g., the cow 170) housed in the stall 155, and is positioned to run at a downward slope starting at a first end of the stall 155 and ending at a second end of the stall 155. In one embodiment, for example, the above-ground bank of tubing 113 is sloped downward between the first end 113a and the second end 113b such that the first end 113a sits about 6 inches higher than the second end 113b (e.g., the loop 115a at the first end of the stall 155 is about 6 inches higher than loop 115a at the second end of the stall 1155), thereby providing about a 1 inch drop per 1 foot of the length l from the first end 113a to the second end 113b, such that the tubing 113 has a slope ranging from about 0.083 to about 0.1, and is sloped at an angle of about 4 degrees to about 6 degrees relative to the plane P_{H}. As discussed above, the final curl 115b at the second end 113b of the tubing 113 is then curled downward at about a 90-degree angle and further slanted (i.e., relative to the horizontal plane P_{H}) such that the straight length of tubing 115c slopes at the angle θ until reaching the outlet curl 125 (which empties into the fluid return line 102).

Those of ordinary skill in the art would understand that the above-described application is exemplary only and based on the dimensions of a standard cow stall. It would be understood that geothermal loops of the present disclosure may be incorporated into various types of open-air structures, including barns with and without stalls for housing livestock, and that a respective above-ground bank of tubing 113/rack 114 can therefore be sized to accommodate the geometry of any given application (e.g., the dimensions (width and length) of any give stall) and are not limited to accommodating the standard 4×6 cow stalls described herein.

In some embodiments, for example, the geothermal loop 110 utilizes the posts 109 to support and run the at least one fluid supply line 101 and the at least one fluid return line 102 up to the elevated location of the pumping device 130 and the above-ground bank of tubing 113 (i.e., such that the fluid supply line 101 can connect with an intake orifice 128 of the pumping device 130 and the fluid return line 102 can connect with the outlet curl 125 of the tubing 113). In some embodiments, as illustrated in FIG. 1, the at least one fluid supply line 101 can be run up or within one side of a respective post 109 and the at least one fluid return line 102 can be run up or within another side of the respective post 109. As also illustrated in FIG. 1, in some additional embodiments, electrical service lines 112 (e.g., configured for about 115 to 120 volts) can also be run along or through one or more of the posts 109 to provide power to the pumping device 130. As further shown in FIG. 1, clamps, or other attachment mechanisms, 111 can also be used to affix the lines 101 and 102 to the ground (e.g., as they rise from the below-ground tubing field 103 to the ground surface 106) and/or to the posts 109 (e.g., as they run between the ground surface 106 and the elevated location of the rack 114). Similar clamps 111 can also be used to affix the electrical service lines 112 to the posts 109. The pumping device 130 functions to draw cooled fluid (e.g., water) up from the below-ground tubing field 103, via the at least one fluid supply line 101 that runs, for example, up one or more of the posts 109 (see arrows in FIGS. 1, 4, and 5), where it may enter an intake orifice 128 of the pumping device 130 and then flow into the inlet curl 122 of the tubing 115 via an outtake orifice 129 of the pumping device 130 (see FIG. 5). An example of a pumping device that may be used within the geothermal cooling systems of the present disclosure is described, for example, in U.S. Pat. No. 3,490,379, entitled “Circulating Pump,” the entire contents of which are incorporated by reference herein. Those of ordinary skill would understand, however, that various types of pumping devices and other fluid flow devices may be used in accordance with the present disclosure that function to pump/draw cooled fluid (e.g., water) up from the below-ground tubing field, and that the disclosed circulatory pump is not limited to a particular structure having particular components.

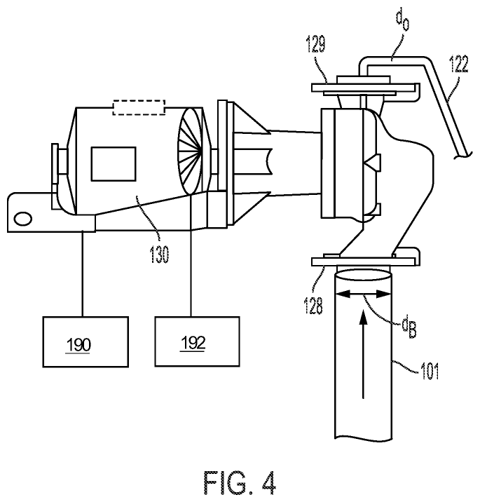

As discussed above, the tubing 115 of the at least one above-ground bank of tubing 113 is configured to provide a downward, gravity-based flow of the water from the at least one fluid supply line 101 (which it receives from the outtake orifice 129 of the pumping device 130) back to and through the at least one fluid return line 102 and from there the below-ground tubing field 103. To further increase the water pressure in the tubing 115 and thereby assist with the downward flow of the water through the tubing 115), an inner diameter d_{O}(see FIG. 4) of the tubing 115 can be less than an inner diameter d_{B} of the fluid supply line 101. In this way, the fluid moves from a wider space to a narrower space as it moves into the least one above-ground bank of tubing 113. In various embodiments, for example, the tubing 115 has an inner diameter d_{O} of about ¼ inches and the inner diameter d_{B} of the supply line 101 ranges from about 1.25 inches to about 1.5 inches. In this manner, the closed-geothermal loop 110 is created, which may circulate water in a constant loop, by drawing cooled water from the below-ground tubing 103 within the ground 160 up into the tubing 113 in the barn 150, where it is used to cool one or more stalls 155 within the barn 150 (e.g., cooling the cows 170 in each of the stalls 155), and then return the water to the below-ground tubing 103, where it is cooled again (prior to once again being drawn up into the barn 150).

Those of ordinary skill in the art will understand that the above-ground bank of tubing 113 illustrated in FIGS. 1, 3, and 5, and discussed in detail above, is exemplary only at that the tubing 115 forming the bank of tubing 113 can have various types, configurations (e.g., overlapping patterns), lengths, diameters, and or materials of the tubing 115 without departing from the scope of the present disclosure and claims. Those of ordinary skill I the art will further understand that the disclosed geothermal cooling system 100 may also include various additional components and/or features to increase the cooling efficiency of the geothermal loop 110.

In some embodiments, for example, the geothermal cooling system 100 may also include one or more fluid blowing devices (e.g., fans 135 (see FIG. 1)), which are configured to move ambient air (e.g., within the interior 152 of the barn 150) over the above-ground bank of tubing 113 as the cooled fluid (e.g., water) coming from the tubing field 103 flows through the tubing 115 (see FIG. 3) of the bank of tubing 113. In this manner, the air blowing over the tubing 113 is cooled through a convective cooling process, as would be understood by those of ordinary skill in the art, and the cooled air is further blown over the one or more stalls 155 (e.g., cooling the cows 170 in each of the stalls 155). The rate of heat loss will depend on the difference in temperatures between the water and the ambient air, and the heat transfer coefficient, as would be further understood by those of ordinary skill in the art.

Gravity is then used to move the warmed water downward toward the outlet curl 125 and return it to the below-ground tubing field 103. Embodiments of the present disclosure contemplate, for example, utilizing the standard 36″ fans, which are generally already installed in most dairy barns in accordance with standard industry practice. In this manner, the geothermal cooling system 100 may utilize the geothermal loop 110 to efficiently, cost-effectively, and in an environmentally-friendly manner cool livestock (e.g., cows 170) protected by the open-air structure 150 through a simple convection cooling process, via continued movement of the cooled water through the above-ground bank of tubing 113, without utilizing more costly and complicated components, such as, for example, those associated with refrigerant-based or fossil-fuel-based heat pumps and HVAC systems.

With reference to FIG. 4, in some additional embodiments, the geothermal cooling system 100 may further include one or more sensors, such as, for example, temperature sensors 190, and a control system (e.g., thermostat 192), which may be configured, for example, to activate the geothermal loop 110 (i.e., turn on the pump 130) whenever the ambient temperature within the interior 152 of the barn 150 reaches or exceeds a threshold temperature and to deactivate the geothermal loop 110 (i.e., turn off the pump 130) whenever the ambient temperature with the interior 152 of the barn 150 falls below or obtains the threshold temperature. For example, in such embodiments, the thermostat 192 may be configured to turn on the pump 130 when the ambient temperature reaches a temperature of about 70 degrees F. to about 80 degrees F., such as for example, to turn on the pump 130 when the temperature reaches about 70 degrees F. to about 80 degrees F., and to turn off the pump 130 when the ambient temperature falls below about 70 degrees F. to about 80 degrees F.

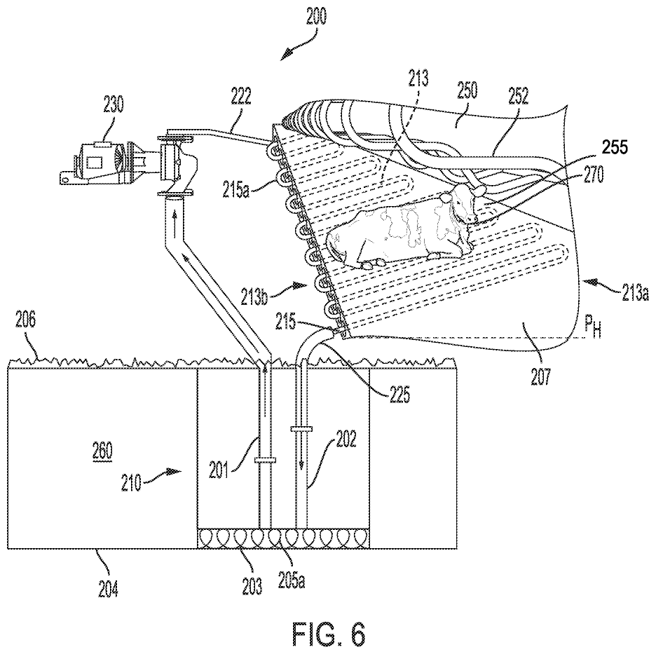

Those of ordinary skill in the art will further understand that the geothermal cooling system 100 described above with reference to FIGS. 1-5 is exemplary only and that the contemplated geothermal cooling systems and methods can have various configurations, including various configurations of open-air structures and geothermal loops, without departing from the present disclosure and claims. With reference now to FIGS. 6-9, another embodiment of a geothermal cooling system 200 for an open-air structure in accordance with the present disclosure is illustrated.

The geothermal cooling system 200 includes an open-air structure 250 (only a portion being shown for simplicity purposes) configured, for example, to house livestock, including, but not limited to, at least one cow 270, and a geothermal loop 210. Similar to the geothermal cooling system 100 of FIGS. 1-5, in FIG. 6, the geothermal cooling system 200 is depicted in a sectional view, starting at an excavated surface 204, for example, about 10 feet below a ground surface 206, and extending above the ground surface 206 to the barn 250, and the geothermal loop 210 is configured to cool at least a portion of an interior 252 of the barn 250. Similar to the geothermal loop 110, the geothermal loop 210 includes a below-ground tubing field 203, at least one above-ground bank of tubing 213 fluidically coupled with the below-ground tubing field 203, and a circulatory pump 230. The below-ground tubing field 203, like the below-ground tubing field 103, includes one or more series of overlapping tubing 205a. At least one fluid supply line 201 and at least one fluid return line 202 fluidically coupling the below-ground tubing field 203 to the above-ground bank of tubing 213, similar to the manner discussed above to create a closed loop system. As the general components of the system 200 are similar to that of system 100 described above they are not further discussed in detail here and it should be understood that the components may be similar and have similar configurations and arrangements, with differences between the systems discussed below.

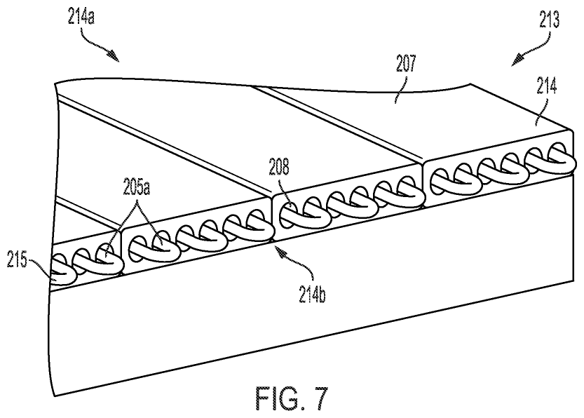

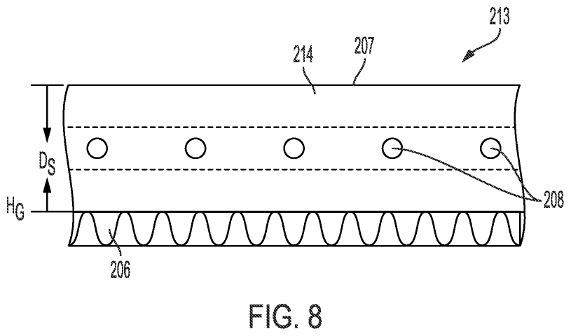

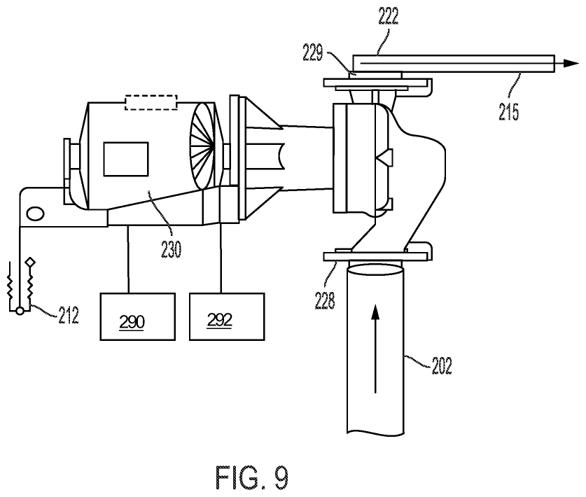

In contrast to the above-ground bank of tubing 113 positioned at an elevated location of an open-air structure, the above-ground bank of tubing 213 is positioned at a ground level location/height H_{G}, which rests on or is positioned relatively close to the ground surface 206 (see FIG. 8), such as, for example, within a floor structure 207 of the open-air structure 250. As discussed above, when placed within the geothermal loop 210, the above-ground bank of tubing 213 is fluidically coupled with the below-ground tubing field 203 via the at least one fluid supply line 201 and the at least one fluid return line 202. As best illustrated perhaps in the partial, isolated view of FIG. 7, in some embodiments, the above-ground bank of tubing 213 includes a continuous length of tubing 215 in multiple loops in an overlapping series 215a between an inlet section 222 of the tubing 215 (see FIGS. 6 and 9) and an outlet section 225 of the tubing 215 (see FIG. 6). In various embodiments, for example, the tubing 215 has an outer diameter of about ⅜ inches and an inner diameter of about ¼ inches.

As discussed above and illustrated in FIG. 6, the above-ground bank of tubing 213 is positioned at a ground level location, such as, for example, at a floor structure 207 of the open-air structure 250, and is arranged at an overall downward slope (i.e., relative to a horizontal plane P_{H} that is substantially parallel with the ground surface 206) between a first end 213a of the bank of tubing 213 and a second end 213b of the bank of tubing 213, such that an elevation of the first end 213a is higher than an elevation of the second end 213b.

As best illustrated in the enlarged, partial views of FIGS. 7 and 8, in some embodiments, the coiled tube 215 is routed through passages 208 within the floor structure 207, such as, for example, through concrete slabs 214 that can form a floor structure 207. In one embodiment, each concrete slab 214 may include a plurality of passages 208, extending along a length of the slab 214 between a first end 214a of the slab (which corresponds with the first end 213a of the tubing 213) and a second end 214b of the slab 214 (which corresponds with the second end 213b of the tubing 213), and which are spaced approximately two inches apart from one another and have a diameter of about 9.6 mm.

In some embodiments, for example, in accordance with the standard dimensions of a cow stall, each concrete slab 214 has a width of about 4 feet and a length of about 6 feet, with the continuous, coiled tube 215 forming loops 215a that curl 180° back-and-forth in a snake pattern each time the tubing 115 reaches an end 214a, 214b of the concrete slab 214. In this manner, a respective above-ground bank of tubing 213/slab 214 can be placed within each stall 255 (e.g., cow stall) of an open-air structure 250 that is in the form of a barn 250, such that the above-ground bank of tubing 213 is positioned below an animal (e.g., the cow 270) housed in the stall 255. The above-ground bank tubing 213 can be positioned to run at a downward slope starting at a first end of the stall 255 and ending at a second end of the stall 255. In one embodiment, for example, the floor structure 207 (e.g., each slab 214) forms a sloped bed of a respective stall 255, such that the floor structure (e.g., each slab 214) is sloped downward between the first end (e.g., corresponding to 214a of each slab 214) and the second end (e.g. corresponding to 214b of each slab 214). In one embodiment, the floor structure is positioned such that the above-ground bank of tubing 213 is sloped downward between the first end 213a and the second end 213b such that the first end 213a is located about 6 inches higher than the second end 213b (e.g., a top surface of the first end 214a of the slab 214 is about 6 inches higher than a top surface of the second end 214b of the slab 214), thereby providing about a 1 inch drop per 1 foot of the length from the first end 213a of the tubing 213 to the second end 213b of the tubing 213, such that the tubing 213 has a slope ranging from about 0.083 to about 0.1, and is sloped at an angle of about 4 degrees to about 6 degrees relative to the plane P_{H}. Furthermore, each slab 214 has a depth D_{S} (see FIG. 8) that is configured to bear the weight of a cow 270 stepping and/or laying down on the slab 214, such that the above-ground bank of tubing 213 is protected within the passages 208 of the slab 214. Those of ordinary skill in the art will understand that the depth D_{S} of the flooring structure 207 (e.g., each slab 214) can be either constant or variable depending upon a particular application and how one chooses to provide the required sloping.

Similar to the above-described pumping device 130, a pumping device 230 functions to draw cooled fluid (e.g., water) up from the below-ground tubing field 203, via the at least one fluid supply line 201, where it may enter an intake orifice 228 of the circulatory pump 230 and then flow into the inlet section 222 of the coiled tube 215 via an outtake orifice 229 of the circulatory pump 230 (see FIG. 9). In one embodiment, the circulatory pump 230 can be powered by a hard-wired electrical service 212 (see FIG. 9), for example, with 115 to 120 volts, to turn an impeller that pulls water from the below-ground tubing field 203. As above, an exemplary circulatory pump is described, for example, in U.S. Pat. No. 3,490,379, which is incorporated by reference herein.

Thus, in the same manner as the above-ground bank of tubing 113, the above-ground bank of tubing 213 is configured to provide a downward flow of the water from the at least one fluid supply line 201 (which it receives from the outtake orifice 229 of the pumping device 230) back to the at least one fluid return line 202. In accordance with various embodiments, for example, the continuous tubing 215 is positioned within the slab 214 to run at a downward slope, for example, starting at a first end of a stall 255 within the barn 250 and ending at a second end of the stall 255. Additionally, as further discussed above, to increase the fluid pressure into the continuous, coiled tubing 215 (thereby assisting with the downward flow in the continuous tubing 215), an inner diameter of the tubing 215 is less than an inner diameter of the fluid supply line 201, in a manner similar to that discussed above with respect to FIGS. 1-5. In this manner, the closed geothermal loop 210 is created, which may also circulate the fluid (e.g., water) in a loop, by drawing cooled fluid (e.g., water) from the below-ground tubing 203 within the ground 160 up into the tubing 213 in the open-air structure 250, where it is used to cool one or more stalls 255 or other regions of the open-air structure 250 (e.g., cooling the cows 270 therein), and then return the water to the below-ground tubing 203, where it is cooled again (prior to once again being drawn up to the open-air structure 250).

For example, the cooled fluid (e.g., water) coming from the tubing field 203 flows through the tubing 215 of the bank 213, where it is warmed from the body heat of the cow 270 resting on the slab 214. Thus, like the above geothermal loop 110, the geothermal loop 210 utilizes a simple convective cooling process to cool the cow 270. Gravity is then used to move the warmed water downward toward the outlet section 225 of the tube 215 and return it to the below-ground tubing field 203.

Those of ordinary skill in the art will understand that the above-ground bank of tubing 213 illustrated in FIGS. 6-8, and discussed in detail above, is exemplary only at that such tubing 213 can have various types, configurations, and/or lengths of tubes 215, which have various diameters, and which are formed into various configurations of loops 215a, which run in various configurations of passages 208, within various types and sizes of slabs 214 made from various materials, without departing from the scope of the present disclosure and claims. For example, although in the embodiment described above, it is contemplated that an individual slab 214 is used in each stall 255 of the barn 250, it is further contemplated that a single slab 214 may span more than one stall 255 or a whole row of the stalls 255 within the barn 250. Those of ordinary skill in the art will also understand that above-ground bank of tubing 213 may be embedded in various types of ground level structures (e.g., pads and/or beds), which are suitable for animals to stand, walk, and/or lay down on, and are not limited to the slabs 214 described with reference to the embodiment of FIGS. 6-8.

Those of ordinary skill in the art will further understand that the disclosed geothermal cooling system 200 may also include various additional components and/or features to increase the cooling efficiency of the geothermal loop 210. In some embodiments, for example, similar to the geothermal cooling system 100, as illustrated in FIG. 9, the geothermal cooling system 200 may also include one or more sensors, such as, for example, temperature sensors 290, and a control system (e.g., thermostat 292), which may be configured, for example, to activate the geothermal loop 210 (i.e., turn on the pump 230) whenever the ambient temperature within the interior 252 of the barn 250 reaches or exceeds a threshold temperature and to deactivate the geothermal loop 210 (i.e., turn off the pump 230) whenever the ambient temperature with the interior 252 of the barn 250 falls below or obtains the threshold temperature. For example, in such embodiments, a sensor may be configured to turn on the pump 230 when the ambient temperature reaches a temperature of about 70 degrees F. to about 80 degrees F., such as, for example, to turn on the pump 230 when the temperature reaches about 75 degrees F. to about 80 degrees F., and to turn off the pump 230 when the ambient temperature falls below about 70 degrees F. to about 80 degrees F.

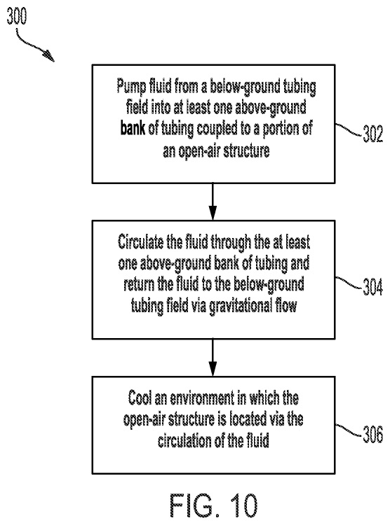

Referring now to FIG. 10, an exemplary method 300, which can be implemented using the geothermal cooling systems 100, 200 described above with reference to FIGS. 1-9, to cool an open-air structure is shown. As described above, contemplated geothermal cooling systems 100, 200 include an open-air structure and a closed, geothermal loop. The open-air structure is configured to provide protection while allowing free movement of air between the interior and an external environment, and the geothermal loop is in thermal communication with the open-air structure to cool at least a portion of the environment in which the open-air structure is located. For example, the geothermal loop includes a below-ground tubing field and at least one above-ground bank of tubing, which are connected via a pumping device.

At step 302, the pumping device is used to pump fluid (e.g., water) from the below-ground tubing field into the at least one above-ground bank of tubing that is coupled to a portion of an open-air structure (e.g., is positioned within a portion of a barn). Where, at step 304, the water is circulated through the at least one above-ground bank of tubing and returned to the below-ground tubing field via a gravitational flow.

At step 306, an environment in which the open-air structure is located (e.g., a portion of an interior of the barn) is cooled (e.g., thereby cooling livestock within the barn), via the circulation of the cooled water through the at least one above-ground bank of tubing. In one embodiment, warm ambient air is blown over the cooled water flowing through the above-ground bank of tubing, to produce a convective cooling effect. In another embodiment, body heat (e.g., from an animal housed within the barn) is used to warm the cooled water flowing through the above-ground bank of tubing to produce the convective cooling effect. The contemplated methods may therefore, utilize a closed geothermal loop to efficiently, cleanly (i.e., without environmental impact), and cost effectively cool open-air structures, and the animals housed within the open-air structures, through a simple convection cooling process via continued movement of cooled water through the above-ground bank of tubing.

This description and the accompanying drawings that illustrate exemplary embodiments should not be taken as limiting. Various mechanical, compositional, structural, electrical, and operational changes may be made without departing from the scope of this description and the claims, including equivalents. In some instances, well-known structures and techniques have not been shown or described in detail so as not to obscure the disclosure. Furthermore, elements and their associated features that are described in detail with reference to one embodiment may whenever practical, be included in other embodiments in which they are not specifically shown or described. For example, if an element is described in detail with reference to one embodiment and is not described with reference to a second embodiment, the element may nevertheless be included in the second embodiment.

It is noted that, as used herein, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Further, this description's terminology is not intended to limit the disclosure. For example, spatially relative terms-such as “upstream,” downstream,” “beneath,” “below,” “lower,” “above,” “upper,” “forward,” “front,” “behind,” and the like—may be used to describe one element's or feature's relationship to another element or feature as illustrated in the orientation of the figures. These spatially relative terms are intended to encompass different positions and orientations of a device in use or operation in addition to the position and orientation shown in the figures. For example, if a device in the figures is inverted, elements described as “below” or “beneath” other elements or features would then be “above” or “over” the other elements or features. Thus, the exemplary term “below” can encompass both positions and orientations of above and below. A device may be otherwise oriented (rotated 90 degrees or at other orientations) and the spatially relative descriptors used herein interpreted accordingly.

Further modifications and alternative embodiments will be apparent to those of ordinary skill in the art in view of the disclosure herein. For example, the systems may include additional components that were omitted from the diagrams and description for clarity of operation. Accordingly, this description is to be construed as illustrative only and is for the purpose of teaching those skilled in the art the general manner of carrying out the systems and methods of the present disclosure. It is to be understood that the various embodiments shown and described herein are to be taken as exemplary. Elements and materials, and arrangements of those elements and materials, may be substituted for those illustrated and described herein, parts and processes may be reversed, and certain features of the present teachings may be utilized independently, all as would be apparent to one skilled in the art after having the benefit of the description herein. Changes may be made in the elements described herein without departing from the scope of the present disclosure.

It is to be understood that the particular examples and embodiments set forth herein are non-limiting, and modifications to structure, dimensions, materials, and methodologies may be made without departing from the scope of the present disclosure. Other embodiments in accordance with the present disclosure will be apparent to those skilled in the art from consideration of the specification and practice of the invention disclosed herein. It is intended that the specification and examples be considered as exemplary only, with being entitled to their full breadth of scope, including equivalents.

What is claimed is:

1. A geothermal cooling system for an open-air structure, the system comprising:
an open-air structure;
a closed, geothermal loop configured to cool an environment in which the open-air structure is located, the geothermal loop comprising:
a below-ground tubing field comprising one or more tubing loops;
at least one above-ground bank of tubing coupled to a portion of the open-air structure;
at least one fluid supply line fluidically coupling the below-ground tubing field and the at least one above-ground bank of tubing;
at least one fluid return line fluidically coupling the below-ground tubing field and the at least one above-ground bank of tubing; and
at least one pump operably coupled to the fluid supply line and configured to apply a pressure differential sufficient to draw fluid from the below-ground tubing field through the fluid supply line and into the at least one above-ground bank of tubing,
wherein the at least one above-ground bank of tubing is arranged to circulate the fluid via gravity through the at least one above-ground bank of tubing and return the fluid to the below-ground tubing field through the at least one fluid return line.

2. The geothermal cooling system of claim 1, wherein the below-ground tubing field comprises multiple overlapping loops of flexible tubing.

3. The geothermal cooling system of claim 2, wherein the below-ground tubing field comprises a continuous coil.

4. The geothermal cooling system of claim 2, wherein the flexible tubing comprises high-density polyethylene (HDPE) tubing.

5. The geothermal cooling system of claim 1,
wherein the at least one above-ground bank of tubing extends from a first end fluidically coupled to the at least one fluid supply line to a second end fluidically coupled to the at least one fluid return line, and
wherein the first end is elevated relative to the second end.

6. The geothermal cooling system of claim 1, wherein the at least one above-ground bank of tubing is made of copper.

7. The geothermal cooling system of claim 1, wherein the at least one above-ground bank of tubing is a continuous length of tubing in an overlapping pattern.

8. The geothermal cooling system of claim 1, wherein a diameter of the tubing of the at least one above-ground bank of tubing is smaller than a diameter of the at least one fluid supply line.

9. The geothermal cooling system of claim 1, further comprising a fluid blowing device configured to blow air from the environment in which the open-air structure is located over the at least one above-ground bank of tubing.

10. The geothermal cooling system of claim 1, wherein the open-air structure comprises one or more of a floor structure or a roof structure and the at least one above-ground bank of tubing is in thermal communication with the one or more of the floor structure or the roof structure.

11. The geothermal cooling system of claim 10, wherein the open-air structure comprises a floor structure and the at least one above-ground bank of tubing comprises a continuous length of tubing routed through passages in the floor structure.

12. The geothermal cooling system of claim 10, wherein the one or more of the floor structure or the roof structure is sloped and the at least one above-ground bank of tubing comprises a continuous length of tubing arranged such that an elevation of a first end of the tubing fluidically coupled to the at least one fluid supply line is higher than an elevation of a second end of the tubing fluidically coupled to the at least one fluid return line.

13. The geothermal cooling system of claim 1, wherein the geothermal loop is configured to circulate water.

14. The geothermal cooling system of claim 1, wherein the open-air structure comprises a barn configured to house livestock.

15. The geothermal cooling system of claim 14, wherein the barn comprises a stall configured to house the livestock, and wherein the above-ground bank of tubing is installed at the stall.

16. The geothermal cooling system of claim 1, wherein the fluid comprises water.

17. A method for cooling an open-air structure, the method comprising:
pumping fluid from a below-ground tubing field into at least one above-ground bank of tubing, the at least one above-ground bank of tubing being coupled to a portion of an open-air structure;
circulating the fluid through the at least one above-ground bank of tubing and returning the fluid from the at least one above-ground bank of tubing to the below-ground tubing field via gravitational flow; and
cooling an environment in which the open-air structure is located via the circulation of the fluid through the at least one above-ground bank of tubing.

18. The method of claim 17, wherein circulating the fluid through the at least one above-ground bank of tubing comprises circulating the fluid through a continuous, length of tubing in thermal communication with one or more of a floor structure or a roof structure of the open-air structure.

19. The method of claim 18, further comprising blowing air from the environment in which the open-air structure is located over the at least one above-ground bank of tubing.

20. The method of claim 17, wherein the open-air structure is a barn configured to house livestock, and wherein circulating the fluid through the at least one above-ground bank of tubing comprises circulating the fluid through a continuous length of tubing positioned above a stall in the barn, at a downward slope, from a first end of the stall to a second end of the stall.

21. The method of claim 17, wherein the open-air structure is a barn configured to house livestock, and wherein circulating the fluid through the at least one above-ground bank of tubing comprises circulating the fluid through a continuous length of tubing routed through passages in a floor structure of a stall in the barn, at a downward slope, from a first end of the stall to a second end of the stall.

22. The method of claim 17, wherein the fluid comprises water.
